(19) United States
(12) Patent Application Publication
(10) Pub. No.: US 2006/0095556 A1
(43) Pub. Date: May 4, 2006

(54) Method and apparatus for automating collaboration over communications devices

(76) Inventors: James F. Arnold, Helena, MI (US); Adam J. Cheyer, Oakland, CA (US); Michael W. Frandsen, Helena, MT (US); Shane C. Mason, Helena, MT (US); Ayse Onalan, Bellevue, WA (US)

Correspondence Address: MOSER, PATTERSON & SHERIDAN, LLP;SRI INTERNATIONAL, 595 SHREWSBURY AVENUE, SUITE 100, SHREWSBURY, NJ, 07702, US

(21) Appl. No.: 11/262,404

(22) Filed: Oct. 28, 2005

Related U.S. Application Data
(63) Continuation-in-part of application No. 10/867,612, filed on Jun. 14, 2004.
(60) Provisional application No. 60/478,440, filed on Jun. 12, 2003.

(51) Int. Cl. G06F 15/173

(52) U.S. Cl. 709/223

(57) ABSTRACT

In one embodiment, a method for automating or arranging a group communication among at least two participants includes receiving a user request (e.g., from one of the participants) for the group communication and delegating at least a portion of the user request to at least one service provider for processing. Delegation is based on general strategies for satisfying user requests, as well as knowledge of the capabilities of the available service providers.

### CROSS REFERENCE TO RELATED APPLICATIONS

This application is a continuation-in-part of U.S. patent application Ser. No. 10/867,612, filed Jun. 14, 2004, which in turn claims the benefit of U.S. Provisional Patent Application Ser. No. 60/478,440, filed Jun. 12, 2003, both of which are herein incorporated by reference in their entireties.

### FIELD OF THE INVENTION

The present invention relates generally to mobile communications devices and relates more specifically to multi-party communications using mobile communications devices.

### BACKGROUND OF THE DISCLOSURE

Always-on, always-connected communication to mobile devices will drive the next great communications market, much as the Internet did in the 1990s. New products, applications and services will emerge, creating entirely new patterns of behavior.

Present day mobile systems have limited capability to address the needs of this emerging market, as such systems tend to be limited by current interface paradigms (e.g., small keyboards and displays) and require users to engage in tedious and time consuming low-level tasks. Incompatibility of services with currently available devices (e.g., due to computational or human interface issues) and a lack of available security also tend to dissuade prudent consumers from using their mobile devices for the transmission of sensitive data such as commercial transactions.

Thus, there is a need in the art for a method and apparatus for automating collaboration over mobile communications devices.

### SUMMARY OF THE INVENTION

In one embodiment, a method for automating or arranging a group communication among at least two participants includes receiving a user request (e.g., from one of the participants) for the group communication and delegating at least a portion of the user request to at least one service provider for processing. Delegation is based on general strategies for satisfying user requests, as well as knowledge of the capabilities of the available service providers.

### BRIEF DESCRIPTION OF THE DRAWINGS

The teachings of the present invention can be readily understood by considering the following detailed description in conjunction with the accompanying drawings, in which:

FIG. 1 illustrates a flow diagram that depicts one embodiment of a method for group communication and collaboration using mobile devices, in which features of the present invention may be deployed;

FIG. 2 illustrates a flow diagram that depicts one embodiment of a method for searching resources according to the present invention, in which features of the present invention may be deployed;

FIG. 3 illustrates a flow diagram that depicts one embodiment of a method for preserving data integrity during media access using mobile communications devices, according to the present invention;

FIG. 4 illustrates a flow diagram that depicts one embodiment of a method for annotating and sharing resources, in which features of the present invention may be deployed;

FIG. 5 is a high-level block diagram illustrating an exemplary embodiment of a system for automating collaboration, according to the present invention;

FIG. 6 is a flow diagram illustrating one embodiment of a method for automating group communications, according to the present invention; and

FIG. 7 is a high level block diagram of the present method for group communication and collaboration that is implemented using a general purpose computing device.

To facilitate understanding, identical reference numerals have been used, where possible, to designate identical elements that are common to the figures.

### DETAILED DESCRIPTION

The present invention relates to a method for automating or arranging group collaborations (e.g., conference calls) involving two or more participants. In one embodiment, a method and system are provided that enable users in physically diverse locations to easily arrange group collaborations or communications. The present invention takes advantage of a distributed computing architecture that combines multiple services and functionalities to respond to user requests in the most efficient manner possible.

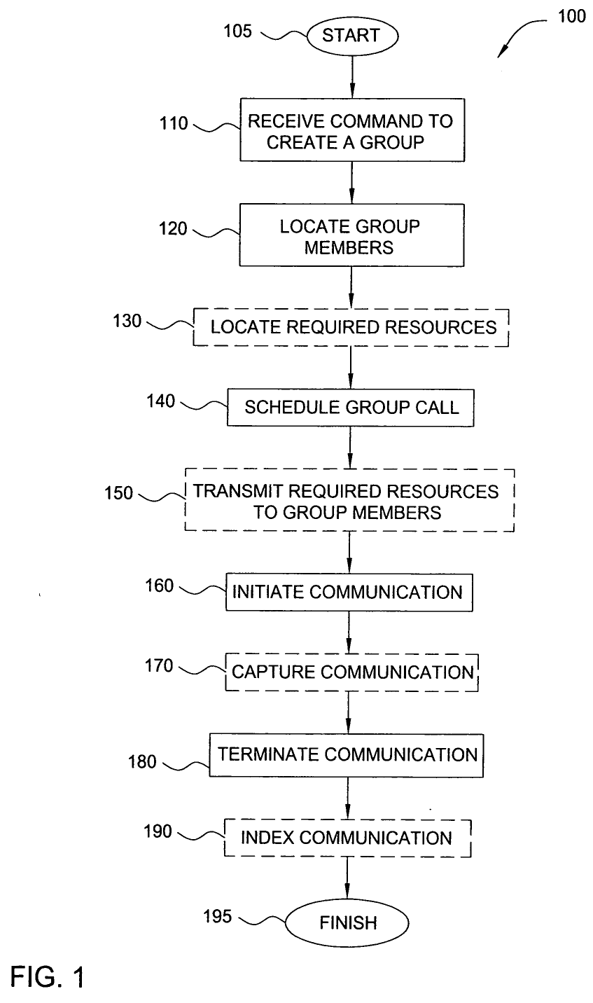

FIG. 1 illustrates a flow diagram that depicts one embodiment of a method 100 for group communication and collaboration using mobile devices, in which features of the inventive method for data preservation may be deployed. Optional steps in the method 100 are indicated by dashed boxes. The method 100 is initialized at step 105 and proceeds to step 110, where the method 100 receives a user command to create a group. In one embodiment, the command is a verbal command, such as, “Set up a secure conference call no later than 12 PM today with Mike, Ben, Alice and Jan at MBA&J, Inc., to discuss the revisions to the widget contract”. In one embodiment, the method 100 parses the verbal command using conventional speech recognition and/or natural language programs, in order to extract names (and, optionally, their affiliations) and the purpose of the requested communication. In one embodiment, the method 100 “listens” for keywords in the received command, in order to limit the number of potential tasks to a group that might reasonably be requested.

Once the method 100 has received and parsed a user command, the method 100 proceeds to step 120 and locates the requested group members (e.g., Mike, Ben, Alice and Jan in the above example). In one embodiment, location of group members is accomplished through interaction of the method 100 with a networked calendar/scheduling service (e.g., Microsoft Exchange or Yahoo! Calendar) or a client-resident calendaring program (e.g., Palm Desktop). In another embodiment, the method 100 uses structured electronic mail communications, generated speech telephonic communications or similar means in step 120 to query the group members in regards to their availability and preferred means of contact for the requested collaboration. In one embodiment, if the method 100 cannot determine availability and contact information for one or more requested group members, the method 100 queries the mobile device user requesting the collaboration and stores the responses for future communications. In another embodiment, scheduling is enabled to include participants for whom electronic calendar services are not available.

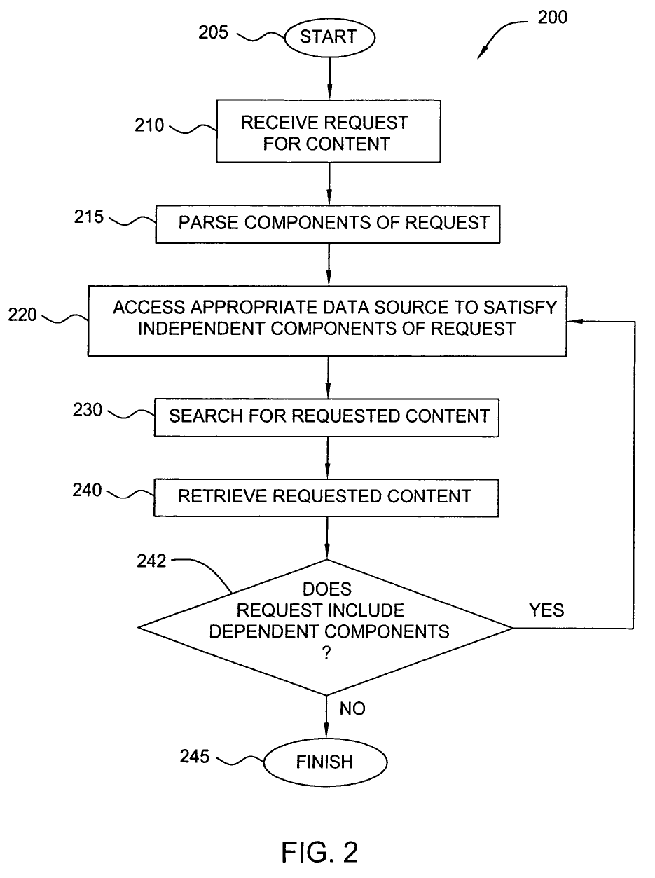

In one embodiment, the method 100 proceeds to step 130 after locating the requested group members and locates any resources referred to in the user command. For example, in the example above, the method 100 might locate and retrieve the “widget contract” for use in the requested conference call. In one embodiment, resources are located according to a method described in greater detail with reference to FIG. 2.

Once the location and availability information for the requested group members and any necessary resources have been retrieved, the method 100 proceeds to step 140 and collates the retrieved information, together with any constraints set forth in the original user command (e.g., no later than 12 PM today”), to determine an available time to schedule the group communication (e.g., the conference call). In one embodiment, conventional constraint reasoning programs are employed by the method 100 to perform the collation. In another embodiment, the method 100 queries the user to resolve conflicts, to determine if one or more requested group members are unnecessary, or to execute alternative scheduling strategies. For example, depending on the urgency and required resources (e.g., if a document must be collaboratively edited), alternative times may be preferable for collaboration, or user feedback may be solicited to resolve conflicting requirements that are not simultaneously achievable. In one embodiment, a spoken language interface is used to solicit feedback from the user. In one embodiment, user feedback is stored and indexed if the strategy embodied therein is of a general nature, so that the method 100 may rely on such feedback to resolve future conflicts without interrupting the user.

In one embodiment, the method 100 also determines the cost and appropriateness of alternative means of communication while scheduling the collaboration in step 140. For example, the method 100 may consider means such as landline telephone service, cellular networks, satellite or the Internet, among others. For example, if all group members will be desk-bound at the proposed collaboration time, different (and more capable) devices would likely be available than if the group members were at the airport using, for example, cellular telephones. The cost of each means may be considered, along with an assessment of the means's appropriateness, which may be based on the capability and available bandwidth of the group members' devices.

This estimation can be made based on information from a number of sources, including carrier-provided ‘presence detection’ (e.g., whether a user is in a cell phone service area, with the phone on), internet presence (e.g., as provided by instant messenger programs such as those available from America Online and Yahoo!) and the known data rate capacities of each available medium. Personal calendar information and GPS applications can also indicate a person's location (e.g., a location on a road, especially if varying or moving, may indicate that a voice conversation via a cell channel is most appropriate; if the user is in the office, a video conference may be more appropriate). User preferences, either directly set by the user (e.g., “never schedule meetings before 9 AM!”), or learned experientially by observing user behavior at various times and locations, can also be used. Information pertaining to the costs of certain communications options could be stored locally on user devices, or a remotely in a service providers' database.

At step 150, the method 100 transmits any required resources (e.g., the resources retrieved in step 130) to the group members. In one embodiment, the resources are transmitted using a secure communication channel.

Once the method 100 has successfully scheduled a group communication, the method 100 proceeds to step 160 and initiates communication between the members of the group at the scheduled time. In one embodiment, the established communication is limited to audio communication and can be established using traditional telephony services, using voice-over-IP (VoIP), or using any other appropriate means for initiating audio communication. In another embodiment, the established communication employs richer, multi-modal communications and utilizes protocols for simultaneous audio, video and text communication and document sharing, or any combination thereof. In one embodiment, the multi-modal communications means is Microsoft NetMeeting or video conferencing.

In one embodiment, the method 100 records the group communication at step 170. In one embodiment, the recorded communication is stored at a central server supplied, for example, by a communications or other service provider. In another embodiment, the recorded communication is stored locally on a user device (e.g., commercially available memory cards for cell phones may store approximately 500 hours of voice data). Once the group communication has completed (e.g., accomplished any necessary tasks), the method 100 terminates the group communication at step 180. In one embodiment, if the method 100 has recorded the group communication, the method 100 indexes the group communication at step 190. In one embodiment, indexing of the group communication involves the use of speech-to-text systems, natural language analysis and keyword spotting technologies to determine topic boundaries in the group communication. The method 100 terminates at step 195.

FIG. 2 illustrates a flow diagram that depicts one embodiment of a method 200 for searching resources, in which features of the inventive method for data preservation may be deployed as described further below. The method 200 may be implemented, for example, in step 130 of the method 100 to locate resources required by a user's given command for a group communication. The method 200 is an intelligent media access and discovery application that allows a user to discover and retrieve distributed media, regardless of format, location or application in a simple, user-friendly manner.

The method 200 is initiated at step 205 and proceeds to step 210, where the method 200 receives a request for content (e.g., one or more resources). In one embodiment, the request is received via a natural language interface.

In step 215 the method 200 parses the received request for components of the request. Some requests may contain only a single component (e.g., “Look up the box score for last night's Cubs game”). More complex requests may involve multiple layers of queries. For example, if the request is, “Look up the box score for last night's Cubs game and download video highlights”, the method 200 is asked to fulfill two components of the request: (1) Look up the box score for last night's Cubs game; and (2) Download the video highlights. In this example, the two components of the request may be referred to as independent components, because each component is independent of the other. That is, each component can be satisfied on its own, without requiring any knowledge or satisfaction of the other component. For example, the method 200 does not need to know what the box score of the Cubs game is in order to retrieve the game's video highlights, and vice versa.

Alternatively, the method 200 may receive a request having multiple components that are not entirely independent of each other, such as, “Play an MP3 of the song Justin Timberlake performed at last night's MTV awards”. In this case, there is a dependent component of the request (e.g., play the song) that cannot be addressed or satisfied until an independent component (e.g., identify the song) is satisfied first. That is, the method 200 cannot search for or play the requested song until the method 200 knows for which song it is looking. In other embodiments, a request may include multiple dependent components of arbitrary dependency. For example, a request to “Do A, B, C and D” could include the dependencies “A before B”, “A before C”, “C before B” and “B before D”. In one embodiment, standard methods in the art of graph theory are employed to detect any cycles in dependencies that may render the dependencies inherently unable to be satisfied.

Once a request for content is parsed into components, the method 200 proceeds to step 220 and selects the appropriate data sources for the requested content, starting in one embodiment with the independent components. In one embodiment, the method 200 has access to a wide variety of data sources, including, but not limited to, the World Wide Web and public and private databases. Data source selection according to step 220 may be performed based on a number of criteria. In one embodiment, data source selection is performed using topic spotting, e.g., analyzing natural language contained within the received request to determine a general area of inquiry. For the example request above, topic spotting could reveal “sports” or “baseball” as the general area of inquiry and direct the method 200 to appropriate data sources. In one embodiment, narrowing data source selection enables a more efficient search (e.g., identifies fewer, more accurately disposed data sources).

In step 230, the method 200 searches the selected data sources for the requested content. In one embodiment, one or more of the data sources are indexed and searched thereby. In one embodiment, the data sources are indexed and searched according to the methods described in co-pending, commonly assigned U.S. patent application Ser. No. 10/242,285, filed Sep. 12, 2002 by Stringer-Calvert et al. (entitled “Methods and Apparatus for Providing Scalable Resource Discovery”), which is herein incorporated by reference. In other embodiments, the method 200 may implement any efficient searching technique in step 230.

In step 240, the method 200 retrieves the requested content (e.g., any independent components of the request). In one embodiment, retrieved content is directly presented to the user. In another embodiment, the retrieved content is stored for future presentation and/or reference.

In step 242, the method 200 asks if the request received in step 210 includes any outstanding dependent components that may now be searched based on content retrieved for independent components. If the request does not contain any outstanding dependent components, the method 200 terminates in step 245. If the request does include outstanding dependent components, the method 200 repeats steps 220-240 for the outstanding dependent components. Content retrieved for the independent components may be used to aid in the search for content requested in a dependent request component (e.g., may be used to narrow data source selection or search within data sources).

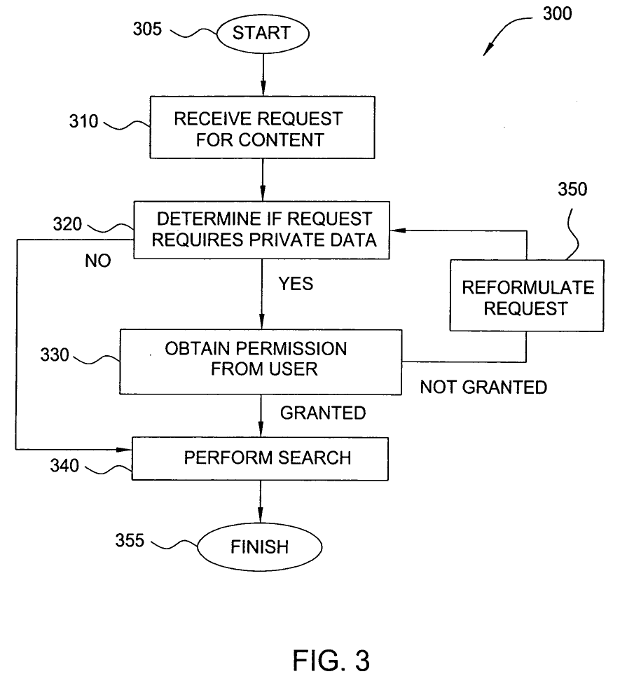

FIG. 3 illustrates a flow diagram that depicts one embodiment of a method 300 for preserving data integrity during media access using mobile communications devices, according to the present invention. The method 300 may be implemented, for example, as an enhancement to the method 200 and deployed in step 130 of the method 100 to locate resources required by a user's given command for a group communication. The method 300 is an intelligent media access and discovery application that allows a user to discover and retrieve distributed media without compromising the user's private information (e.g., location or more general user information).

The method 300 is initialized at step 305 and proceeds to step 310, where the method 300 receives a request for content from a user. In one embodiment, the request is received in the form of a natural language query, although, in other embodiments, other forms of query may be received.

In step 320, the method 300 analyzes the received request for private information. In one embodiment, private information is defined as any information stored in a mobile device's local knowledge base, and may include, for example, the user's address, social security number, credit card information, phone number, stored results of previous requests and the like. In one embodiment, private information further includes the output of sensors, such as GPS receivers, coupled to the mobile device. For example, if the received request is, “Tell me how to get to the nearest copy center”, the method 300 understands the relative term “nearest” to be in relation to the user's current location, for example as sensed by a GPS receiver, and information pertaining to the user's current location is considered potentially private.

If the method 300 determines that the received request does not involve any potentially private information, the method 300 proceeds to step 340 and performs a search for the requested content, for example in accordance with the method 200, although alternative searching methods may be employed. Alternatively, if the method 300 determines that the received request does involve potentially private information, the method 300 proceeds to step 330 to obtain user permission to proceed with the search for content. In one embodiment, the query includes the information that would be shared in the execution of the search, for example in the form of a warning dialog such as, “Performing this search would require divulging the following private information: your current location. Proceed?”. Those skilled in the art will appreciate that other dialogs may be employed depending on the type of private information that may be revealed.

If the method 300 obtains permission from the user in step 330, the method 300 proceeds to step 340 and performs the search for the requested content, as described above. If the method 300 does not obtain user permission, the method 300 proceeds to step 350 and reformulates the user's request, if possible, in order to phrase the request in terms that do not require the revelation of private information. In one embodiment, reformulation in accordance with step 350 uses templates that provide hints for alternate request construction. For example, a template could suggest that in the case of location information, a larger geographic region (such as a city or zip code) be given instead of an exact location. Thus, the request for a copy center could be reformulated as, “What copy centers are there in San Francisco?”, thereby revealing less private information. Once the request is reformulated, the method 300 repeats steps 320 and 330 (and, possibly, 350), until the method 300 receives or produces a request that the user approves, and then performs a search in step 340.

Alternatively, once the request has been reformulated, the method 300 may proceed directly to step 340, without further request for user permission. In another embodiment, the method 300 may provide the user with an option to cease receiving requests for permission. The method 300 then terminates in step 355.

In one embodiment, search results relating to locations (e.g., a list of copy centers in San Francisco) contain geographic coordinates or addresses from which geographic coordinates may be calculated. Simple arithmetic over the coordinates could then determine the appropriate (e.g., nearest) location. In another embodiment, several individual locations are displayed to the user on a local map along with a marker for the user's present location.

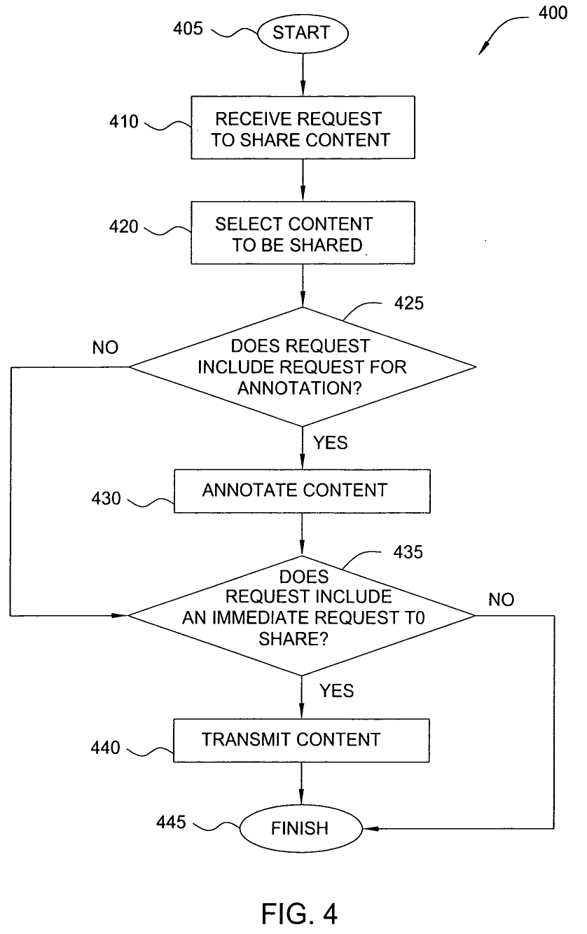

FIG. 4 illustrates a flow diagram that depicts one embodiment of a method 400 for annotating and sharing resources, in which features of the present data preservation method may be deployed. The method 400 is a collaboration application that enables effective annotation and sharing of resources, such as digital photographs. In one embodiment, the method 400 for sharing resources may be executed simultaneously with a multi-way communication, e.g., to allow users to share what they are doing at any moment during the communication. The interfaces provided by present day devices such as camera phones and digital cameras do not generally make it easy for users to annotate and distribute images, as they tend to be tedious, lacking in functionality or require additional devices (such as personal computers) to accomplish the annotation and transfer.

The method 400 is initialized at step 405 and proceeds to step 410, where the method 400 receives a request to annotate and/or share content. For example, the request may be a verbal command such as, “Name this ‘Tommy's First Hit’” or “Call Grandpa Bob and share this” or “Send Grandma the picture of Tommy's First Hit”.

In step 420, the method 400 selects the content to be shared and/or annotated, based upon the request received in step 410. In one embodiment, references to “this” (e.g., “Name this ‘Tommy's First Hit’”) are interpreted in step 420 to mean either the media object that the user is currently viewing, or, if the user is not currently viewing a media object, the media object most recently captured on the user's device (e.g., the last digital photograph taken).

In step 425, the method 400 determines whether the request received in step 410 includes a request to annotate content. If the request does include a request for annotation, the method 400 annotates the content in step 430, and proceeds to step 435, where the method 400 further determines if the request received in step 410 includes an immediate request to share content with another individual. Alternatively, if the method 400 determines in step 425 that the request received in step 410 does not include a request to annotate content, the method 400 proceeds directly to step 435. In one embodiment, annotation in accordance with step 430 is accomplished using joint photographic experts group (JPEG) comments, extensible markup language (XML) markup, moving picture experts group (MPEG) description fields or other conventional methods of annotation.

If the method 400 determines in step 435 that the request received in step 410 includes an immediate request to share content, the method 400 proceeds to step 440 and transmits the indicated content to the intended recipient(s). The method 400 then terminates in step 445. Alternatively, if the method 400 determines that the request received in step 410 does not include an immediate request to share content, the method 400 proceeds directly to step 445 and terminates.

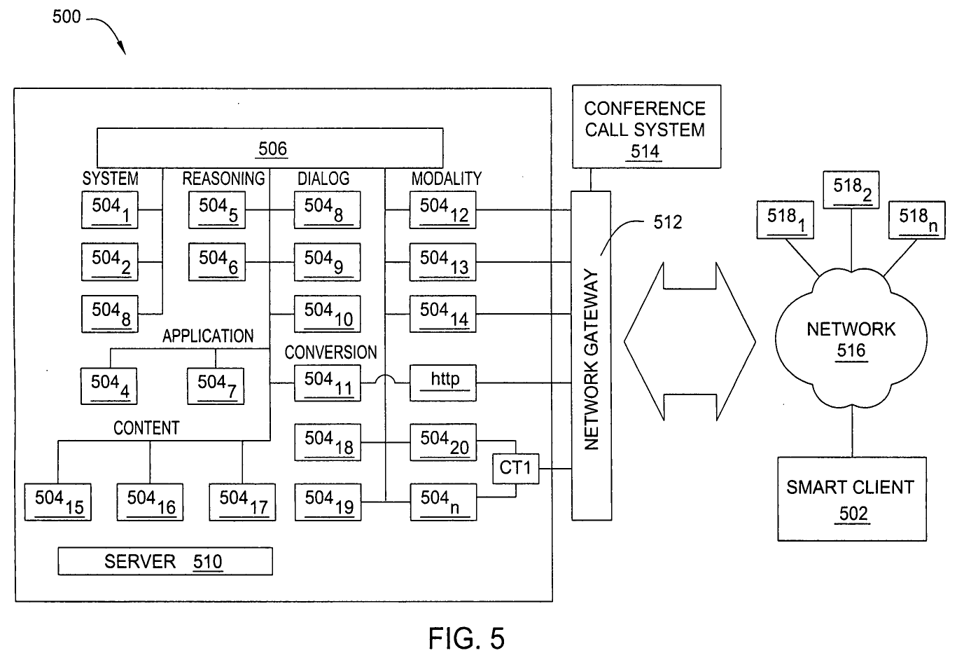

FIG. 5 is a high-level block diagram illustrating an exemplary embodiment of a system 500 for automating collaboration, according to the present invention. The system 500 may be implemented to facilitate the collaboration of multiple individuals spread over geographically diverse locations, as described above (e.g., with respect to FIG. 1).

In one embodiment, the system 500 comprises four main components: a requester, one or more providers 504₁-504ₙ (hereinafter collectively referred to as “providers 504”), a facilitator 506 and one or more strategy agents 508. In one embodiment, the system 500 further comprises an information management server 510 that stores personal information for a user and/or individuals with whom the user communicates, such as calendar and contact information.

The system 500 may be further coupled to at least one computing network 516 (e.g., a global system for mobile communications (GSM) network, a public switched telephone network (PSTN), an internet protocol (IP) network or the like), via a network gateway 512 (e.g., an IP or voice over IP (VoIP) gateway). The network gateway 512 may be further coupled to a conference call system. In addition, one or more user devices 518₁-518ₙ (hereinafter collectively referred to as “user devices 518”), such as desktop computers, handsets, landline telephones and the like, or smart clients 502, may be coupled to the network 516.

The requester is configured to receive a user request (e.g., a request to schedule a conference call) and to specify this request to the facilitator 504. In further embodiments, the requester additionally provides advice to the facilitator 504 on how to satisfy the user request. In one embodiment, one or more of the providers 504 double as requesters.

The providers 504 are service providers that each perform one or more functions that may be useful in satisfying the user request. Each of these providers registers with the facilitator by specifying its capabilities and limitations. In one embodiment, the providers include at least one of: modality agents (e.g., for controlling devices and/or input/output streams, like phone, email, short message services and the like), dialog agents (e.g., for managing user login and sessions, receiving and processing incoming user requests and coordinating outbound communications), conversion agents (e.g., for translating between information formats, such as text-to-speech), content agents (e.g., for managing data records and providing interfaces for creating, updating and removing data, such as a calendar repository or user preference database), application agents (e.g., for wrapping the functionality of an underlying application or system, such as a wrapper for a conference call system), system agents (e.g., for performing system-level functionality, such as a time alarm, a monitor or a debugger), reasoning agents (e.g., for performing various kinds of inference or learning relevant to the application domain, such as scheduling or constraint reasoning). Providers 504 may be dynamically added to or removed from the system 500.

For example, a phone modality agent 504₁₂ may monitor and use a telephone by interfacing with an underlying phone control system to answer and hang up the telephone line and to listen for touchtone presses. The phone modality agent 504₁₂ may not have any intelligence about the user interaction, e.g., when the telephone is answered, the phone modality agent 504₁₂ may simply broadcast that event to interested parties. In such an event, a dialog agent (e.g., a phone dialog agent 504₈) will listen to and take over the interaction. In some embodiments, a phone modality agent 504₁₂ may be a text-to-speech phone modality agent for performing speech recognition.

The phone dialog agent 504₈ controls the phone dialog with the user by controlling and coordinating multiple concurrent phone dialogs. In one embodiment, the phone dialog agent 504₈ may request the user to login and authenticate him or herself. In another embodiment, the phone dialog agent 504₈ coordinates with a speech recognition agent 504₂₀ (to understand voice inputs), a text-to-speech agent 504ₙ (to send voice outputs) and the phone modality agent 504₁₂ (to understand touchtone inputs) in order to interact with the user. Furthermore, the phone dialog agent 504₈ may delegate incoming requests (e.g., from speech) for natural language translation, execute requests, and/or ask for results to be prepared in a form appropriate for communication back to the user.

An email modality agent 504₁₃ may monitor and use an email server, e.g., in order to define procedures for sending and receiving emails. Like the phone modality agent 504₁₂, the email modality agent 504₁₃ may not have any intelligence regarding the user interaction (e.g., does not define solvables to search, retrieve, get or delete emails), but simply broadcasts received email messages to interested parties. The received email may indicate the start of a new user session or request or may be received in response to an email sent by the system 500 to the user. An associated email dialog agent (e.g., a email dialog agent 504₉) will listen to and take over the interaction.

The email dialog agent 504₉ controls the email dialog with the user by controlling and coordinating multiple concurrent email dialogs (e.g., where email sessions may be kept track of using email headers). In one embodiment, the email dialog agent 504₉ listens for broadcast events from the email modality agent 504₁₃ or other providers 504, to ask or inform the user via email. Furthermore, the phone dialog agent 504₉ may delegate incoming requests (e.g., from email) for natural language translation, execute requests, and/or ask for results to be prepared in a form appropriate for communication back to the user.

A short messaging service (SMS) modality agent 504₁₄ may monitor and use an SMS server, e.g., in order to define procedures for sending and receiving SMS messages. Like the phone modality agent 504₁₂ and the email modality agent 504₁₃, the SMS modality agent 504₁₄ may not have any intelligence regarding the user interaction, but simply broadcasts received SMS messages to interested parties. An associated SMS dialog agent (e.g., an SMS dialog agent 504₁₀) will listen to and take over the interaction.

The SMS dialog agent 504₁₀ controls the SMS dialog with the user by controlling and coordinating multiple concurrent SMS dialogs (e.g., where SMS sessions may be kept track of using SMS headers). In one embodiment, the SMS dialog agent 504₁₀ listens broadcast events from the SMS modality agent 504₁₄ or other providers 504, to ask or inform the user via SMS. Furthermore, the SMS dialog agent 504₁₀ may delegate incoming requests (e.g., from SMS) for natural language translation, execute requests, and/or ask for results to be prepared in a form appropriate for communication back to the user. In addition, the SMS dialog agent 504₁₀ may handle the dialog state for results or questions that must be sent in a plurality of SMS messages (e.g., where the lengths of individual SMS messages are limited).

In one embodiment, a single text dialog agent (not shown) may be implemented to incorporate the functionalities of both the email dialog agent 504₉ and the SMS dialog agent 504₁₀.

A web dialog agent 504₁₁ controls a web server by controlling and coordinating multiple concurrent web dialogs (e.g., where web sessions may be initiated by web browsers). In one embodiment, the web dialog agent 504₁₁ accepts user requests (e.g., in natural language form input into a text area of a form) and also presents a user with a list (e.g., in hyperlink form) of system capabilities at the time the user request is made. In order to summarize the system capabilities, the web dialog agent 504₁₁ is enabled to query other providers 504 for their respective capabilities and to combine the results.

A text-to-speech agent 504ₙ is a conversion agent that synthesizes an input text string and streams the synthesized samples to the appropriate destination based on the session identification. The text-to-speech agent 504ₙ may also generate and/or play a synthesized audio form of a text string over a specified audio port.

A speech recognition agent 504₂₀ is a conversion agent that listens to input audio speech (e.g., a user speaking) and generates a textual interpretation of what the input audio speech. For example, the speech recognition agent 504₂₀ may receive a request from the phone dialog agent 504₈ indicating that speech input being received should be recognized. The speech recognition agent 504₂₀ may, in response, accept the request and inform the phone dialog agent 504₈ that it has started listening. To this end, the speech recognition agent 504₂₀ may send notifications as speech is started, ended and recognized.

A natural language parser agent 504₁₈ is a conversion agent that converts natural language textual input into a request that can be delegated to one or more other providers 504 (e.g., expressed in a language understandable by the providers 504). To this end, the natural language parser agent 504₁₈ is able to interpret basic human language (e.g., English) sentence structure and to dynamically extend with vocabulary for specific domains. In one embodiment, application and/or content agents define new vocabulary to be used in parsing sentences. In another embodiment, the natural language parser agent 504₁₈ returns an expression of what words in the input were understood.

A natural language generator agent 504₁₉ is a conversion agent that converts input expressed in a language understandable by the providers 504 into content that can be rendered using a dialog agent (e.g., by generating simple human language sentences and structures that can be extended with vocabulary for a specific domain).

A contact agent 504₁₆ is a content agent that maintains a repository of contacts (e.g., contact information such as email addresses and phone numbers for other individuals). To this end, the contact agent 504₁₆ allows searching, adding, editing and deletion of contact records.

A calendar agent 504₁₇ is a content agent that maintains a calendar repository of appointments. To this end, the calendar agent 504₁₇ allows searching, adding, editing and deletion of appointments.

A conference agent 504₇ is an application agent that initiates, adds participants to and ends a conference call. To this end, the conference agent 504₇ includes logic to check for the presence of participants and to take action accordingly. In one embodiment, the conference agent 504₇ uses features of a conference call system accessed via simple object access protocol (SOAP) interface. Thus, in one embodiment, the conference agent 504₇ is a wrapper around a SOAP client for the conference call system's web services. The conference agent 504₇ may also define additional functions that combine those defined in the web services description language (WSDL).

A scheduler agent 504₅ is a reasoning agent that schedules conference calls. To this end, the scheduler agent 504₅ retrieves contacts and calendar and scheduling preference information for participants and subsequently identifies the best solutions for scheduling the user request. Once the solution is identified, the scheduler agent 504₅ requests further action from other providers 504 (e.g., updating the calendars, sending notifications, initiating the conference call, etc.). In addition, the conference scheduler agent 504₅ resolves or retrieves any missing or ambiguous input parameters of a user request (e.g., regarding participants, time constraints, etc.). This may be accomplished by looking up the missing or ambiguous parameters in context first, and then requesting resolution from one or more other providers 504 if the missing or ambiguous parameters are not found in context. For example, if the ambiguity relates to a participant name, the conference scheduler agent 504₅ may ask a dialog agent (e.g., phone dialog agent 504₈, email dialog agent 504₉, or SMS dialog agent 504₁₀) to resolve the ambiguity by querying the user for clarification.

A constraint reasoner agent 504₆ is a reasoning agent that maintains the consistency of scheduling commitments and provides solutions to new scheduling problems (e.g., by allowing conference call participants to specify meeting schedules and scheduling preferences). To this end, the constraint reasoner agent 504₆ ranks scheduling solutions according to cost (e.g., given a cost function that expresses scheduling preferences) and returns a number of best solutions. In one embodiment, the constraint reasoner agent 504₆ uses specific preferences to present qualitatively different solutions.

A time alarm agent 504₂ is a system agent that monitors time conditions by setting time triggers. For example, the time alarm agent 504₂ may set a time trigger to go off at a single fixed point in time (e.g., “on December 23 at 3:00 PM”) or on a recurring basis (e.g., “every three seconds from now until noon”).

A user database agent 504₁₅ is a content agent that maintains a repository of user preferences, authentication information and other information associated with a particular user. To this end, the user database agent 504₁₅ allows searching, adding, editing and deletion of user information records.

A monitor agent 504₁ is a system agent that provides a graphical console for observing communications and interactions among the set of operating providers 504. To this end, the monitor agent 504₁ allows inspection of an operating provider's published interfaces (e.g., by clicking on the provider's graphical representation) and of live messages passed among providers 504. In further embodiments, the monitor agent 504₁ provides statistics, graphs and reports regarding the sizes and types of messages sent by the system 500.

The facilitator 506 maintains the information regarding the available (registered) providers, as well as a general set of strategies for satisfying user requests. In particular, the facilitator 506 coordinates cooperation among the providers 504, based on knowledge of their capabilities and of the general strategies, in order to satisfy incoming user requests.

The strategy agents 508 contain domain- or goal-specific knowledge and strategies that may be used by the facilitator in devising strategies for satisfying user requests. In one embodiment, strategy agents 508 comprise a subclass of reasoning agents. In particular, the strategy agents 508 reason about other agents or providers 504. For example, a strategy agent 508 may be a modality manager that determines which modalities and communication channels should be used in various situations. In one embodiment, this includes prioritizing the set of available dialog agents or providers 504. To this end, a strategy agent 508 incorporates knowledge of active user communication channels, as well as user preferences, for making intelligent decisions regarding which dialog agent(s)n should be used when many (e.g., for different kinds of modalities) are available to handle the same user request. In one embodiment, a user database agent (e.g., provider 504₁₅) provides user preferences regarding modalities.

In one embodiment, the system 500 further comprises a smart client or graphical user interface application 502 for enhancing multi-modal interaction via portable (e.g., hand-held) user devices. In one embodiment, the smart client 502 includes local providers or agents such as natural language recognition agents, speech recognition agents, text-to-speech conversion agents or world wide web dialog agents. The smart client 502 may enable a user to send requests to the system 500 by filling out web forms, by following web links, by following notification links, by issuing voice requests and responses, by using voice input to fill in a web form field or by sending requests and responses via text input (e.g., using a personal digital assistant).

The configuration of the system 500 enables user requests to be efficiently processed without requiring pre-programming of service providers 504 or agents to process specific user requests or to interact in a specific way. By coordinating and combining the capabilities of the providers 504, portions of the user request can be delegated to the most appropriate providers 504. This allows different providers 504 having different capabilities to be dynamically added to and removed from the automated system 500 as needed.

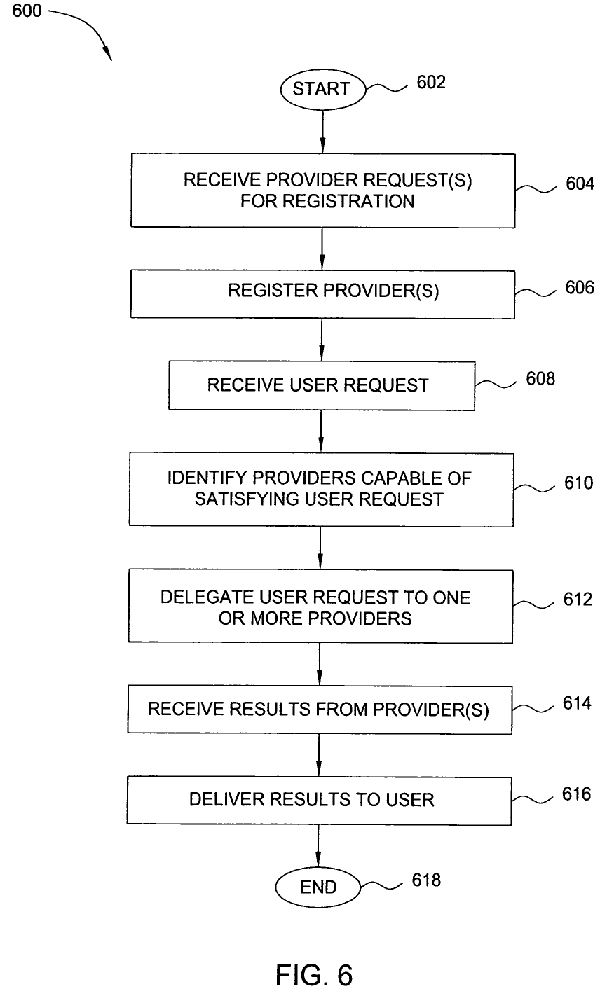

FIG. 6 is a flow diagram illustrating one embodiment of a method 600 for automating group communications, according to the present invention. The method 600 may be implemented, for example, in the facilitator 506 illustrated in FIG. 5.

The method 600 is initialized at step 602 and proceeds to step 604, where the method 600 receives registration requests from one or more service providers. That is, the service providers inform the method 600 of their respective capabilities (e.g., what services they can provide, and limits on their abilities to do so).

In step 604, the method 600 registers one or more of the service providers so that the service providers are capable of providing their services when/if needed to satisfy a user request. In one embodiment, information that must be known in order to register a service provider includes the provider's name (or other means of identification), the provider's functionality and interface, and the provider's human (e.g., English) language associated with the functionality.

Once the service providers have been registered, the method 600 receives a user request in step 608. The user request may be, for example, a request to schedule a conference call with specified individuals on a certain day.

In step 610, the method 600 identifies the service providers that are capable of satisfying the user request. In one embodiment, this first includes interpreting the user request (for example, if the user request is a verbal request received via telephone, the method 600 might perform speech recognition processing in order to translate the verbal request into a text string for easier processing). Thus, one or more service providers may be needed just to interpret the user request. In another embodiment, step 610 further includes decomposing the user request into two or more sub-requests. For example, if the user request is to schedule a conference call with specified individuals on a certain day, the sub-requests may include identifying the participants, identifying the participants' schedules, selecting a time at which all or most of the participants are available, and notifying the participants of the selected time.

In this embodiment, the method 600 may identify a plurality of service providers, where each of the service providers is capable of satisfying a portion of the user request (e.g., one of the sub-requests). For example, the method 600 may query a contact list in order to identify participants and their contact information, a calendar application in order to identify convenient conference call times for the participants within the given constraints, or an email modality agent in order to notify the participants of the selected conference call time and date. In another embodiment, the user request specifies service providers to use, thereby simplifying the identification of the appropriate service providers. In yet another embodiment, the method 600 identifies service providers by broadcasting all or part of the user request (e.g., to solicit capabilities).

In step 612, the method 600 delegates the user request to one or more service providers, in accordance with the manner in which the service providers were identified in step 610. That is, the method 600 delegates to each service provider the portion of the user request that the service provider is to satisfy.

In step 614, the method 600 receives results from the service provider(s) to which the user request was delegated. The method 600 then delivers these results to the user in step 616 (e.g., in the case of a conference call setup, notifies the user of the scheduled time and/or day for the conference call). In step 618, the method 600 terminates.

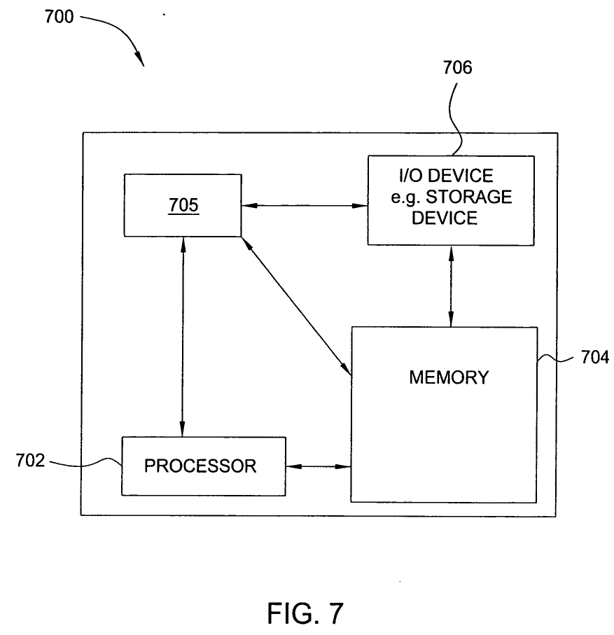

FIG. 7 is a high level block diagram of the present method for group communication and collaboration that is implemented using a general purpose computing device 700. In one embodiment, a general purpose computing device 700 comprises a processor 702, a memory 704, a collaboration module 705 and various input/output (I/O) devices 706 such as a display, a keyboard, a mouse, a modem, and the like. In one embodiment, at least one I/O device is a storage device (e.g., a disk drive, an optical disk drive, a floppy disk drive). It should be understood that the collaboration module 705 can be implemented as a physical device or subsystem that is coupled to a processor through a communication channel.

Alternatively, collaboration module 705 can be represented by one or more software applications (or even a combination of software and hardware, e.g., using Application Specific Integrated Circuits (ASIC)), where the software is loaded from a storage medium (e.g., I/O devices 706) and operated by the processor 702 in the memory 704 of the general purpose computing device 700. Thus, in one embodiment, the collaboration module 705 for automation group collaborations and communications described herein with reference to the preceding Figures can be stored on a computer readable medium or carrier (e.g., RAM, magnetic or optical drive or diskette, and the like).

Thus, the present invention represents a significant advancement in the field of mobile communications. A method and system are provided that enable users in physically diverse locations to easily arrange group collaborations or communications. The present invention takes advantage of a distributed computing architecture that combines multiple services and functionalities to respond to user requests in the most efficient manner possible.

Although various embodiments which incorporate the teachings of the present invention have been shown and described in detail herein, those skilled in the art can readily devise many other varied embodiments that still incorporate these teachings.

What is claimed is:

1. Method for arranging a group communication among at least two participants, said method comprising:
receiving a user request for said group communication; and
delegating at least a portion of the user request to at least one service provider for processing.

2. The method of claim 1, wherein said user request comprises at least one of: a requested day for said group communication, a requested time for said group communication, said at least two participants or at least one constraint on scheduling of said group communication.

3. The method of claim 1, further comprising:
registering said at least one service provider prior to said delegating, such that said at least one service provider is capable of providing an associated service per said delegation.

4. The method of claim 1, further comprising:
receiving processed results from said at least one service provider; and
delivering said processed results to said at least two participants.

5. The method of claim 1, wherein said user is one of said at least two participants.

6. The method of claim 1, wherein said at least one service provider is at least one of: a system agent, a reasoning agent, a dialog agent, a modality agent, an application agent, a content agent or a conversion agent.

7. A computer readable medium containing an executable program for arranging a group communication among at least two participants, where the program performs the steps of:
receiving a user request for said group communication; and
delegating at least a portion of the user request to at least one service provider for processing.

8. An apparatus for arranging a group communication among at least two participants, said apparatus comprising:
means for receiving a user request for said group communication; and
means for delegating at least a portion of the user request to at least one service provider for processing.

9. The apparatus of claim 8, wherein said means for receiving is further adapted to provide advice regarding how to satisfy said user request to said means for delegating.

10. The apparatus of claim 8, wherein said means for delegating maintains information regarding said at least one service provider, including at least one of: a name of said at least one service provider, a functionality of said at least one service provider, an interface of said at least one service provider and a human language associated with said functionality.

11. The apparatus of claim 8, wherein said means for delegating maintains a general set of strategies for satisfying user requests including said user request.

12. The apparatus of claim 8, wherein said at least one service provider is dynamically added to and removed from said apparatus.

13. The apparatus of claim 8, wherein said at least one service provider is at least one of: a system agent, a reasoning agent, a dialog agent, a modality agent, an application agent, a content agent or a conversion agent.

14. The apparatus of claim 13, wherein said system agent performs at least one system-level functionality with regard to said arranging.

15. The apparatus of claim 13, wherein said reasoning agent performs at least one kind of inference or learning relevant to an application domain associated with said user request.

16. The apparatus of claim 13, wherein said dialog agent manages incoming and outgoing communications with regard to said arranging.

17. The apparatus of claim 13, wherein said modality agent controls devices and input/output streams associated with said apparatus.

18. The apparatus of claim 13, wherein said application agent wraps a functionality of an underlying application or system.

19. The apparatus of claim 13, wherein said content agent manages data records.

20. The apparatus of claim 13, wherein said conversion agent translates between a first information format and a second information format.

21. The apparatus of claim 8, further comprising:
at least one strategy agent for maintaining domain- or goal-specific information for use in devising strategies to satisfy said user request.
